(19) United States
(12) Patent Application Publication
(10) Pub. No.: US 2014/0105769 A1
(43) Pub. Date: Apr. 17, 2014

(54) METHOD FOR FABRICATING ELECTRIC WIRE FOR WINDING OF SUPER-HIGH HEAT-RESISTANT MOTOR PUMP, ELECTRIC WIRE FABRICATED BY THE METHOD, AND MOTOR PUMP HAVING THE ELECTRIC WIRE

(71) Applicant: Gap-Dong KIM, Busan (KR)

(72) Inventor: Gap-Dong KIM, Busan (KR)

(21) Appl. No.: 14/014,533

(22) Filed: Aug. 30, 2013

(30) Foreign Application Priority Data
Oct. 12, 2012 (KR) 10-2012-0113313
Oct. 12, 2012 (KR) 10-2012-0113317

(51) Int. Cl. F04D 25/06; H01B 7/29; H01B 19/00

(52) U.S. Cl. CPC F04D 25/0693; H01B 19/00; H01B 7/292
USPC 417/423.7; 29/887; 174/122 R

(57) ABSTRACT

Disclosed herein is a method for fabricating an electric wire for a winding of a super-high heat-resistant motor pump, including: coating a bare copper wire with a first heat-resistant resin layer; applying a woven fiber cladding to an outer surface of the first heat-resistant resin layer; coating an outer surface of the woven fiber cladding with a second heat-resistant resin layer; and applying an inorganic sheath to an outer surface of the second heat-resistant resin layer.

### CROSS REFERENCE TO RELATED APPLICATION

The present disclosure relates to subject matter contained in priority Korean Applications No. 10-2012-0113313 and No. 10-2012-0113317, both filed on Oct. 12, 2012, the entire contents of which are hereby incorporated by references in their entireties.

### BACKGROUND

1. Field

The present disclosure relates to a method for fabricating an electric wire for a winding of a motor pump capable of being used in a super-high temperature condition of 450° C. or more, an electric wire fabricated by the method, and a motor pump having the electric wire.

2. Description of the Related Art

Fire proof clothes used in order to prepare against a fire or an explosion accident, various heat-resistant plastics, a power saving motor, an electronic product, raw materials of semiconductor industry, or the like, should resist a high temperature condition. A process of fabricating a resin used as a raw material of these products is also performed in a high temperature condition. That is, after a thermal fluid is heated to 400° C. or more using a thermal medium boiler increasing a temperature and is circulated through a transfer pipe, a liquid-phase resin raw material is moved through a pipeline in the transfer pipe. Here, when a temperature of the transfer pipe is decreased, the resin raw material may be hardened.

In order to prevent the raw material from being hardened, a high temperature thermal fluid is used. In addition, in order to transfer the thermal fluid, a pump added to an apparatus should also secure a heat-resistance and a durability in a high temperature condition. As a pump for circulating a high temperature thermal fluid, there is a canned motor pump, which includes a centrifugal pump and a motor combined integrally with each other and performs lubrication and cooling by circulating a portion of a pump liquid to a motor or a bearing. Since the pump liquid is introduced into a rotor chamber of the motor, the motor pump is configured in a can shape so that the pump liquid does not permeate into motor components. The canned motor pump is used in a plant, or the like, fabricating a plastic or fabricating a product such as a fiber, or the like, in that all apparatuses are sealed, such that leakage of the liquid or a noise is not generated.

As a temperature of an operating fluid increases, a water cooling structure using a unit such as a cooling jacket disposed at an outer side of the motor pump has been suggested in order to prevent the motor pump from overheating. In this case, a cooling apparatus using a large amount of water can not but be installed, and several problems occur in that water also performs cooling using another energy. That is, a large amount of energy is wasted in order to supply a coolant. In addition, since the installed cooling apparatus is corroded, it should be periodically cleaned within six months to one year. Further, since a used cooler is corroded, it should be replaced per predetermined period.

In order for the motor pump exposed to a high temperature to exhibit a stable performance, one of the important technical problems is that an electric wire wound in the motor resists a high heat. Generally, since a resin material coated on the electric wire may not secure an insulating property at a high temperature, an electric wire capable of resisting the high temperature is required in a super-high heat-resistant motor pump. In addition, in an electric wire for a winding of the super-high heat-resistant motor pump, a material of a coating layer is changed depending on a use temperature. In accordance with the industrial demand, a temperature limit of the pump has gradually increased, and the demand for an electric wire for a winding capable of maintaining a durability and an insulating property even at a temperature of 450° C. or more has increased.

### SUMMARY

An object of the present disclosure is to provide a method for fabricating an electric wire for a winding of a super-high heat-resistant motor pump capable of having a higher heat-resistant performance, and an electric wire fabricated by the method.

Another object of the present disclosure is to provide a super-high heat-resistant motor pump capable of being used at a temperature of 450° C. or more, overcoming a disadvantage of a water cooling scheme, and being directly used in a high temperature condition in an air cooling scheme.

According to an exemplary embodiment of the present disclosure, there is provided a method for fabricating an electric wire for a winding of a super-high heat-resistant motor pump, including: coating a bare copper wire with a first heat-resistant resin layer; applying a woven fiber cladding to an outer surface of the first heat-resistant resin layer; coating an outer surface of the woven fiber cladding with a second heat-resistant resin layer; and applying an inorganic sheath to an outer surface of the second heat-resistant resin layer.

The first heat-resistant resin layer and the second heat-resistant resin layer may include a polyimide based resin, respectively.

The woven fiber cladding may include a plurality of glass fibers woven to intersect with each other in a helical direction.

The method for fabricating an electric wire for a winding of a super-high heat-resistant motor pump may further include, between the coating of the outer surface of the woven fiber cladding with the second heat-resistant resin layer and the applying of the inorganic sheath to the outer surface of the second heat-resistant resin layer, winding the electric wire.

The applying of the inorganic sheath to the outer surface of the second heat-resistant resin layer may include impregnating the wound electric wire in a mixture of a ceramic powder and a polyimide resin in a vacuum condition.

According to another exemplary embodiment of the present disclosure, there is provided a method for fabricating an electric wire for a winding of a super-high heat-resistant motor pump, including: coating a bare copper wire with a polyimide based heat-resistant resin layer; applying a woven fiber cladding to an outer surface of the coated heat-resistant resin layer; and applying a inorganic sheath to an outer surface of the woven fiber cladding.

According to still another exemplary embodiment of the present disclosure, there is provided a method for fabricating an electric wire for a winding of a super-high heat-resistant motor pump, including: applying a woven fiber cladding to an outer surface of a bare copper wire; coating an outer surface of the woven fiber cladding with a polyimide based heat-resistant resin layer; applying a inorganic sheath to an outer surface of the coated heat-resistant resin layer.

The heat-resistant resin layer may include a polyimide based resin.

According to yet still another exemplary embodiment of the present disclosure, there is provided an electric wire for a winding of a super-high heat-resistant motor pump, including: a bare copper wire; a woven fiber cladding applied to an outer surface of the bare copper wire; a heat-resistant resin layer coated on at least any one of the outer surface of the bare copper wire and an outer surface of the woven fiber cladding; and an inorganic sheath applied to the outer surface of the woven fiber cladding or the heat-resistant resin layer.

According to yet still another exemplary embodiment of the present disclosure, there is provided a super-high heat-resistant motor pump including: a casing provided with an inlet and an outlet; an impeller accommodated in the casing; a rotor assembly coupled to the impeller and including a rotor core sealed by a rotor can; and a stator unit having a space part formed to accommodate the rotor assembly therein, configured to provide a rotation force to the rotor assembly, and including a stator unit sealed by a stator can in a state in which an electric wire for a winding is wound around a stator core, wherein the electric wire for a winding includes: a bare copper wire; a woven fiber cladding applied to an outer surface of the bare copper wire; and a heat-resistant resin layer coated on at least any one of the outer surface of the bare copper wire or an outer surface of the woven fiber cladding.

The electric wire for a winding may further include an inorganic sheath applied to an outer surface of the woven fiber cladding or the heat-resistant resin layer.

The heat-resistant resin layer may include: a first heat-resistant resin layer coated on the outer surface of the bare copper wire; and a second heat-resistant resin layer coated on the outer surface of the woven fiber cladding.

The heat-resistant resin layer may include a polyimide based resin, respectively.

The heat-resistant resin layer may include a glass fiber.

The inorganic sheath may be formed by impregnating a ceramic powder in a polyimide resin in a vacuum condition and then drying and curing the ceramic powder.

The stator unit may include a front flange and a rear flange, and the front flange may have a diameter larger than that of the rear flange and be directly coupled to the casing by a flange bolt.

The super-high heat-resistant motor pump may further include: an extension tube extended from one side of the stator unit; and a connector formed at an end portion of the extension tube.

### BRIEF DESCRIPTION OF THE DRAWINGS

FIG. 1 is a schematic cross-sectional view showing a super-high heat-resistant motor pump 100 to which an electric wire for a winding of a super-high heat-resistant motor pump according to an exemplary embodiment of the present disclosure is used;

FIG. 2 is a cross-sectional view showing a stack structure of the electric wire 200 for a winding of a super-high heat-resistant motor pump according to the exemplary embodiment of the present disclosure;

FIG. 3 is a flow chart for describing a method for fabricating an electric wire for a winding of a super-high heat-resistant motor pump according to the exemplary embodiment of the present disclosure;

FIGS. 4A to 4E are process diagrams conceptually showing the method for fabricating an electric wire for a winding of a super-high heat-resistant motor pump according to the exemplary embodiment of the present disclosure;

FIG. 5 is a flow chart for describing a method for fabricating an electric wire for a winding of a super-high heat-resistant motor pump according to another exemplary embodiment of the present disclosure; and

FIG. 6 is a flow chart for describing a method for fabricating an electric wire for a winding of a super-high heat-resistant motor pump according to still another exemplary embodiment of the present disclosure.

### DETAILED DESCRIPTION

Hereinafter, a method for fabricating an electric wire for a winding of a super-high heat-resistant motor pump and an electric wire fabricated by the method according to exemplary embodiments of the present disclosure will be described in detail with reference to the accompanying drawings.

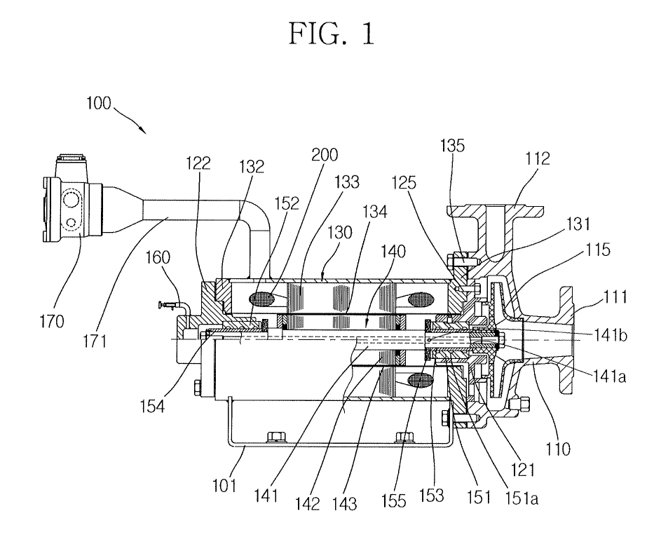

FIG. 1 is a schematic cross-sectional view showing a super-high heat-resistant motor pump 100 to which an electric wire for a winding of a super-high heat-resistant motor pump according to an exemplary embodiment of the present disclosure is used. As shown in FIG. 1, an electric wire 200 for a winding of a super-high heat-resistant motor pump may be used for a winding of the ‘super-high heat-resistant motor pump’ 100, or the like, used in a high temperature condition.

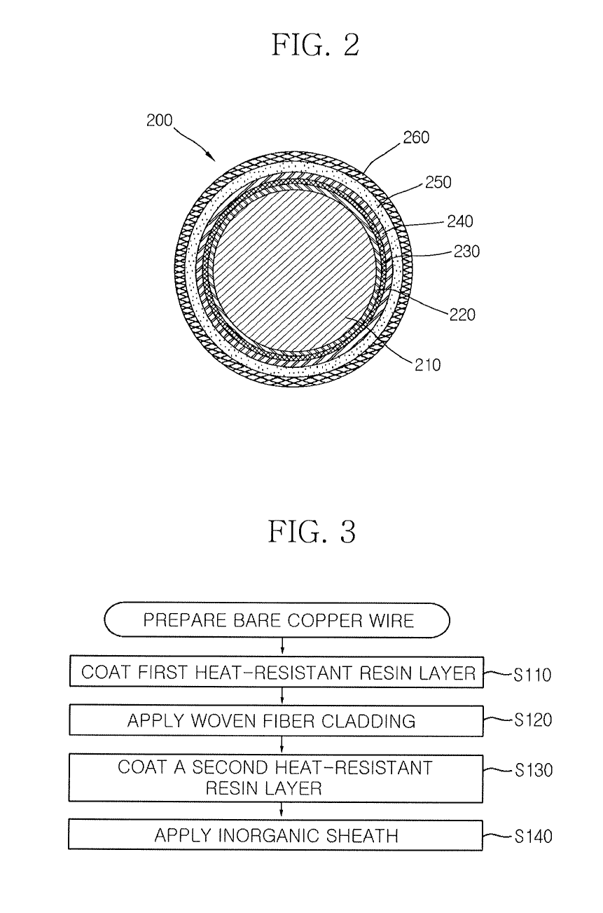

The super-high heat-resistant motor pump 100 may include components such as a casing 110, an impeller 115, a front housing 121, a rear housing 122, a stator unit 130, a rotor assembly 140, bearings 151 and 152, sleeves 155 and 156, an auxiliary impeller 160, a connector 170, and the like. However, in some cases, the super-high heat-resistant motor pump 100 does not include some of the above-mentioned components or may be replaced in another form. Among them, the electric wire for a winding of a super-high heat-resistant motor pump according to the exemplary embodiment of the present disclosure included in the stator unit 130 will be described in detail with reference to FIG. 2.

Again referring to FIG. 1, the casing 110, which is a component enclosing the impeller 115, is provided with an inlet 111 to which an operating fluid, that is, a melted high temperature resin, or the like, is input and an outlet 112 transferring the operating fluid by a centrifugal force.

The impeller 115, which is a component coupled to the rotor assembly 140, receives a driving force provided from the rotor assembly 140 and forcibly guides the operating fluid in a centrifugal direction to allow the operating fluid to move toward the outlet 112 of the casing 110.

The front housing 121 and the rear housing 122 are formed in a form in which they are extended inwardly, respectively, so as to provide seats on which the bearings 151 and 152 are to be seated. In order to couple the front housing 121 and the rear housing 122 to each other, the stator unit 130 is provided with the respective flanges 131 and 132. Here, the front flange 131 may be formed in a form in which it has a diameter larger than that of the rear flange 132 so as to be directly coupled to the casing 110. The front flange 131 and the casing 110 are coupled to each other by a flange bolt 135 inserted from the front flange 131 side. A high sealing force may be obtained and the assembling may be simplified by a direct coupling structure between the stator unit 130 and the casing 110. The front housing 121 is coupled to the front flange 131 of the stator unit 130 by a flange bolt 125 inserted from the front housing 121 side.

The rotor assembly 140 includes a shaft 141, a rotor core 142 fixed to the shaft 141, and a rotor can 143 sealing the rotor core 142. The shaft 141 includes a through-hole 141a formed in a length direction at the center thereof and includes a side hole 141b connected to the through-hole 141a and formed in a radial direction. When the motor is operated, the operating fluid is introduced into through the through-hole 141a by an action of the impeller 111 and is then introduced into an internal space of the motor through the side hole 141b.

A front end and a rear end of the rotor assembly 140 are fitted by the sleeves 153 and 154, respectively, and the sleeves 153 and 154 are supported by the respective bearings 151 and 152. The bearings 151 and 152 include a labyrinth 151a formed in helical and axial directions, and smooth sliding between the shaft 141 and the bearings 151 and 152 is generated by the operating fluid moved along the labyrinth 151a. Therefore, a lubricating action is implemented by the operating fluid transferred by a pump, without using a separate lubricating oil.

The stator unit 130 has a form in which the electric wire 200 is wound around an iron core 133 and is sealed by a stator can 134. A front end portion and a rear end portion of the stator unit 130 are provided with the flanges 131 and 132 so as to be coupled to the front housing 121 and the rear housing 122, respectively, as described above. The electric wire 200 included in the stator unit 130 is a main component that should maintain an insulating property in a high temperature condition. A detailed description of the electric wire 200 will be provided below with reference to FIG. 2. The auxiliary impeller 160 provides a passage for discharging an air included in an internal space in which the rotor assembly 140 is mounted. That is, the auxiliary impeller 160 discharges the air so that the operating fluid is introduced into the internal space by rotation of the impeller 115 after the heat exchange type cooling apparatus for a transformer is operated and is closed when the air is completely discharged.

The connector 170, which is a component connecting the electric wire 200, or the like, of the stator unit 130 to an external terminal, is spaced apart from a high temperature stator unit 130 by a predetermined distance by an extension tube 171. The extension tube 171 allows the connector to be easily handled at the time of an emergency while protecting the connector 170 from the high temperature.

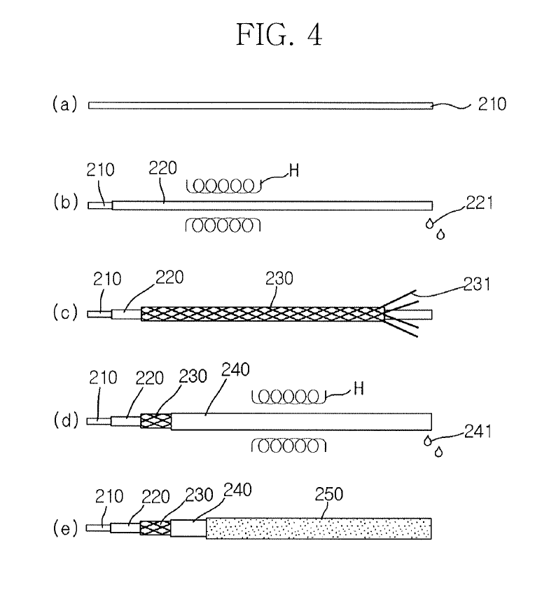

FIG. 2 is a cross-sectional view showing a stack structure of the electric wire 200 for a winding of a super-high heat-resistant motor pump according to the exemplary embodiment of the present disclosure; FIG. 3 is a flow chart for describing a method for fabricating an electric wire for a winding of a super-high heat-resistant motor pump according to the exemplary embodiment of the present disclosure; and FIGS. 4A to 4E are process diagrams conceptually showing the method for fabricating an electric wire for a winding of a super-high heat-resistant motor pump according to the exemplary embodiment of the present disclosure.

As shown in FIGS. 2 to 4E, the electric wire 200 for a winding of a super-high heat-resistant motor pump according to the exemplary embodiment of the present disclosure has a form in which a bare copper wire 210, a first heat-resistant resin layer 220, a woven fiber cladding 230, a second heat-resistant resin layer 240, and an inorganic sheath 250 are sequentially stacked from the center. Although the form in which both of the first and second heat-resistant resin layers 220 and 240 are used has been shown by way of example in FIG. 2, any one of them may also be omitted. The method for fabricating an electric wire for a winding of a super-high heat-resistant motor pump according to the exemplary embodiment of the present disclosure may include coating a first heat-resistant resin layer on a bare copper wire (S110), applying a woven fiber cladding (S120), coating a second heat-resistant resin layer (S130), and applying an inorganic sheath (S140), as shown in FIG. 3. Next, the method for fabricating an electric wire 200 for a winding of a super-high heat-resistant motor pump will be described with reference to FIGS. 4A to 4E.

The bare copper wire, which is in a state of a copper wire for heat-resistant treatment, may be selected to have a diameter according to a capacity of the motor.

The first heat-resistant resin layer 220, which is a heat-resistant layer primarily coated on the bare copper wire 210, may be made of a heat-resistant resin. As the heat-resistant resin, a polyimide based resin 221 having an excellent heat-resistance and fire-resistance may be used. The polyimide resin is a material capable of resisting a high temperature of 400° C. or more. As compared with a scheme according to the related art in which a polyimide resin is stacked after a low melting point resin such as polyolefin, or the like, is used, the polyimide resin is additionally stacked after the bare copper wire is directly coated as in the present embodiment, thereby significantly increasing a heat-resistant temperature. That is, in the case in which the bare copper wire is coated with an adhesive resin such as polyolefin before being coated with the polyimide resin, a heat-resistant temperature is decreased by the polyolefin. However, the polyimide resin is directly attached as in the present embodiment, such that the heat-resistant temperature is not decreased.

As shown in FIG. 4A, a heat is applied to the liquid-phase heat-resistant resin 221 by a heater H in a state in which the bare copper wire is coated with the liquid-phase heat-resistant resin 221, thereby hardening the liquid-phase heat-resistant resin 221.

The woven fiber cladding 230 is coated with a heat-resistant fiber in order to reinforce the bare copper wire 210 coated with the first heat-resistant resin layer 220 and increase a heat resistant feature. The heat-resistant fiber configuring the woven fiber cladding 230, which is a glass fiber enclosing the first heat-resistant resin layer 220 and having a plurality of strands, and may have a form in which the plurality of glass fiber strands are continuously woven to intersect with each other in a helical direction, as shown in FIG. 4B. Since the glass fiber may resist a temperature of 1,000° C. or more, it serves as a heat-resistant part for the first heat-resistant resin layer 220 and the bare copper wire 210 disposed therein.

The second heat-resistant resin layer 240 is filled in a space between the strands of the woven fiber cladding 230 to increase a heat-resistant feature and prevent a run of the woven fiber cladding 230. The second heat-resistant resin layer 240 may also be made of a polyimide based heat-resistant resin 241.

The inorganic sheath 250 fixes the electric wire so as to be maintained in a predetermined form in a state in which a work of winding the electric wire is finished and blocks a heat transferred to the bare copper wire 210 disposed therein. The inorganic sheath 250 may be formed by impregnating a ceramic powder capable of allowing the wound electric wire to resist the high temperature in a polyimide resin in a vacuum condition.

The electric wire 200 for a winding of a super-high heat-resistant motor pump fabricated as described above has an improved durability without a decrease in an insulating property even in an environment in which a temperature of 450° C. or more is continuously maintained. Therefore, the necessity of a coolant for cooling the motor pump or a jacket for circulating the coolant is decreased, such that an economical cost is significantly decreased and a cost is not required for maintenance.

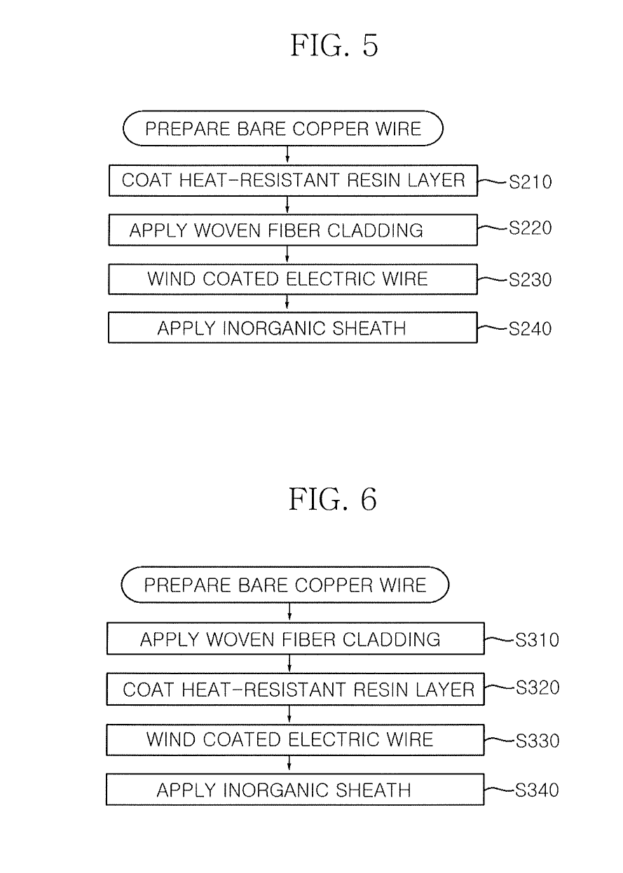

FIG. 5 is a flow chart for describing a method for fabricating an electric wire for a winding of a super-high heat-resistant motor pump according to another exemplary embodiment of the present disclosure. The method fabricating an electric wire for a winding of a super-high heat-resistant motor pump according to another exemplary embodiment of the present disclosure may include coating a heat-resistant resin layer on a prepared bare copper wire (S210), applying a woven fiber cladding to the heat-resistant resin layer (S220), winding the electric wire (S230), and applying an inorganic sheath to the wound electric wire (S240). Here, the heat-resistant resin layer may be made of a polyimide based heat-resistant resin, and the woven fiber cladding may include a glass fiber. A heat-resistant feature is improved by the heat-resistant resin layer and the woven fiber cladding, and the inorganic sheath minimizes permeation of a heat into the bare copper wire disposed therein while maintaining a form.

FIG. 6 is a flow chart for describing a method for fabricating an electric wire for a winding of a super-high heat-resistant motor pump according to still another exemplary embodiment of the present disclosure. The method fabricating an electric wire for a winding of a super-high heat-resistant motor pump according to still another exemplary embodiment of the present disclosure may include applying a woven fiber cladding to a prepared bare copper wire (310), coating a heat-resistant resin layer on the woven fiber cladding (S320), winding the electric wire (S330), and applying an inorganic sheath to the wound electric wire (S340). Here, the heat-resistant resin layer may be made of a polyimide based heat-resistant resin, and the woven fiber cladding may include a glass fiber. However, the method fabricating an electric wire for a winding of a super-high heat-resistant motor pump according to still another exemplary embodiment of the present disclosure is different from the method fabricating an electric wire for a winding of a super-high heat-resistant motor pump according to another exemplary embodiment of the present disclosure in that the heat-resistant resin layer is coated after the woven fiber cladding is applied. In addition, the heat-resistant resin layer may also be formed before and after the woven fiber cladding is applied.

With the method for fabricating an electric wire for a winding of a super-high heat-resistant motor pump according to the exemplary embodiment of the present disclosure, the bare copper wire is compositively coated with the heat-resistant resin layer, the woven fiber cladding, and the inorganic sheath, thereby making it possible to fabricate a motor or a motor pump having a high stability even in a high temperature condition of 450° C. or more.

In addition, since a resistible temperature of the winding serving as a core component of the motor is increased, a cooling jacket and a coolant that are required in a water cooling scheme are not basically required, such that a production cost may be significantly decreased.

The method for fabricating an electric wire for a winding of a super-high heat-resistant motor pump and the electric wire fabricated by the method as described above are not restrictively applied to the configuration and the method of the exemplary embodiments described above. All or some of the above-mentioned exemplary embodiments may also be selectively combined with each other so that various modifications may be made.

What is claimed is:

1. A method for fabricating an electric wire for a winding of a super-high heat-resistant motor pump, comprising:
coating a bare copper wire with a first heat-resistant resin layer;
applying a woven fiber cladding to an outer surface of the first heat-resistant resin layer;
coating an outer surface of the woven fiber cladding with a second heat-resistant resin layer; and
applying an inorganic sheath to an outer surface of the second heat-resistant resin layer.

2. The method for fabricating an electric wire for a winding of a super-high heat-resistant motor pump of claim 1, wherein the first heat-resistant resin layer and the second heat-resistant resin layer include a polyimide based resin, respectively.

3. The method for fabricating an electric wire for a winding of a super-high heat-resistant motor pump of claim 1, wherein the woven fiber cladding includes a plurality of glass fibers woven to intersect with each other in a helical direction.

4. The method for fabricating an electric wire for a winding of a super-high heat-resistant motor pump of claim 1, further comprising, between the coating of the outer surface of the woven fiber cladding with the second heat-resistant resin layer and the applying of the inorganic sheath to the outer surface of the second heat-resistant resin layer, winding the electric wire.

5. The method for fabricating an electric wire for a winding of a super-high heat-resistant motor pump of claim 1, wherein the applying of the inorganic sheath to the outer surface of the second heat-resistant resin layer includes impregnating the wound electric wire in a mixture of a ceramic powder and a polyimide resin in a vacuum condition.

6. A method for fabricating an electric wire for a winding of a super-high heat-resistant motor pump, comprising:
coating a bare copper wire with a polyimide based heat-resistant resin layer;
applying a woven fiber cladding to an outer surface of the coated heat-resistant resin layer; and
applying a inorganic sheath to an outer surface of the woven fiber cladding.

7. A method for fabricating an electric wire for a winding of a super-high heat-resistant motor pump, comprising:
applying a woven fiber cladding to an outer surface of a bare copper wire;
coating an outer surface of the woven fiber cladding with a polyimide based heat-resistant resin layer;
applying a inorganic sheath to an outer surface of the coated heat-resistant resin layer.

8. An electric wire for a winding of a super-high heat-resistant motor pump, comprising:
a bare copper wire;
a first heat-resistant resin layer coated on an outer surface of the bare copper wire;
a woven fiber cladding applied to an outer surface of the first heat-resistant resin layer;
a second heat-resistant resin layer coated on an outer surface of the woven fiber cladding; and
an inorganic sheath applied to an outer surface of the second heat-resistant resin layer.

9. The electric wire for a winding of a super-high heat-resistant motor pump of claim 9, wherein the first heat-resistant resin layer and the second heat-resistant resin layer include a polyimide based resin, respectively.

10. A super-high heat-resistant motor pump comprising:
a casing provided with an inlet and an outlet;
an impeller accommodated in the casing;
a rotor assembly coupled to the impeller and including a rotor core sealed by a rotor can; and
a stator unit having a space part formed to accommodate the rotor assembly therein, configured to provide a rotation force to the rotor assembly, and including a stator unit sealed by a stator can in a state in which an electric wire for a winding is wound around a stator core,
wherein the electric wire for a winding includes:
a bare copper wire;
a woven fiber cladding applied to an outer surface of the bare copper wire; and
a heat-resistant resin layer coated on at least any one of the outer surface of the bare copper wire and an outer surface of the woven fiber cladding.

11. The super-high heat-resistant motor pump of claim 10, wherein the electric wire for a winding further includes an inorganic sheath applied to an outer surface of the woven fiber cladding or the heat-resistant resin layer.

12. The super-high heat-resistant motor pump of claim 10, wherein the heat-resistant resin layer includes:
a first heat-resistant resin layer coated on the outer surface of the bare copper wire; and
a second heat-resistant resin layer coated on the outer surface of the woven fiber cladding.

13. The super-high heat-resistant motor pump of claim 10, wherein the heat-resistant resin layer includes a polyimide based resin.

14. The super-high heat-resistant motor pump of claim 10, wherein the heat-resistant resin layer includes a glass fiber.

15. The super-high heat-resistant motor pump of claim 11, wherein the inorganic sheath is formed by impregnating a ceramic powder in a polyimide resin in a vacuum condition and then drying and curing the ceramic powder.

16. The super-high heat-resistant motor pump of claim 10, wherein the stator unit includes a front flange and a rear flange, and
the front flange has a diameter larger than that of the rear flange and is directly coupled to the casing by a flange bolt.

17. The super-high heat-resistant motor pump of claim 10, further comprising:
an extension tube extended from one side of the stator unit; and
a connector formed at an end portion of the extension tube.
